(19) United States
(12) Patent Application Publication
(10) Pub. No.: US 2002/0014173 A1
(43) Pub. Date: Feb. 7, 2002

(54) Polymeric structured sleeve for flexographic printing

(76) Inventor: Tito Livio Laffitte Ronconi, Pinhais (BR)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/859,670

(22) Filed: May 18, 2001

(30) Foreign Application Priority Data
May 26, 2000 (BR) MU 8000936-0

(51) Int. Cl. B41F 13/10; B41F 27/06

(52) U.S. Cl. 101/376

(57) ABSTRACT

The present patent relates to a polymeric structured sleeve for flexographic printing employed in flexographic printing machines which has special characteristics allowing its insertion on and air mandrel. Having specific design, shape and structure and being of easy handling for better adaptation and safety for the user, easy installation, low manufacturing cost, it is easily adapted to any type of air mandrel used in flexographic printing machines. The present patent comprises the utilization of a polymeric structured sleeve having a cylindrical shape, employed in flexographic printing machines, which is inserted on the mandrel by injecting compressed air allowing an easy and quick installation and/or removal of the sleeve.

The present patent relates to equipment for the printing processes of the flexographic type in general, more specifically the polymeric structured sleeve for flexographic printing used in flexographic machines that because of their characteristics allow its assembly by inserting on a mandrel, With a specific design, shape and structure, easy handling for better comfort and safety for the user, easy installation characteristics, low cost and due to its characteristics and dimensions, it is easily adapted to any kind of mandrel of flexographic printers.

The patent in question is characterized by adding components and processes in a differentiated concept. A concept that provides an efficient, functional and versatile equipment, without loosing its technical qualities, which provides great advantages and improvements to the invention, having general characteristics that differs from the other shapes known in the current state of the art.

The present patent comprises the utilization of a modern, efficient, safe and flexible polymeric structured sleeve of cylindrical shape, used in flexographic printing machines, which is inserted on a cylindrical mandrel by injecting compressed air between the sleeve and the cylindrical mandrel in order to allow an easy and quick installation and/or removal of the sleeve.

It is very versatile, due to its materials, shape and easiness of operation and storage, added to a new manufacturing system that is performed in four steps in a single manufacturing process.

The the current state of the art sleeves, are produced in two manufacturing steps, the first step being the production of a rigid fiberglass tube, structured with epoxy or polyester resin in a tooling mandrel and the second step being the addition of elastomeric polymers on that fiberglass sleeve, and the cure of it through a vulcanizing process, i.e., in general terms the fiberglass tube is manufactured (and has the function of providing radial stiffness and strength for assembly over the mandrel and an elastomeric polymer layer is applied and the vulcanization takes place (having the function of creating flexible layers forming a stiff matrix).

The objectives, advantages and other important features of the present patent can be easily understood when read together with the attached drawings, wherein:

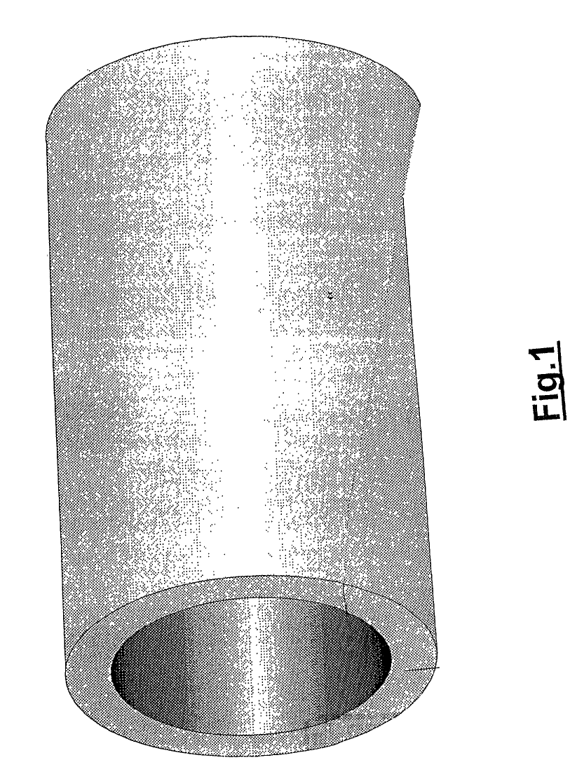

FIG. 1 represents a perspective view of the polymeric structured sleeve.

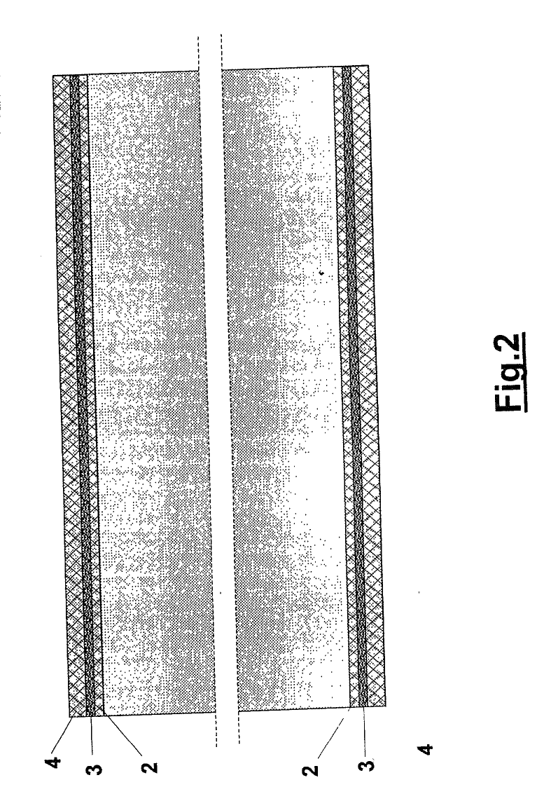

FIG. 2 represents a front, sectional view of the polymeric structured sleeve.

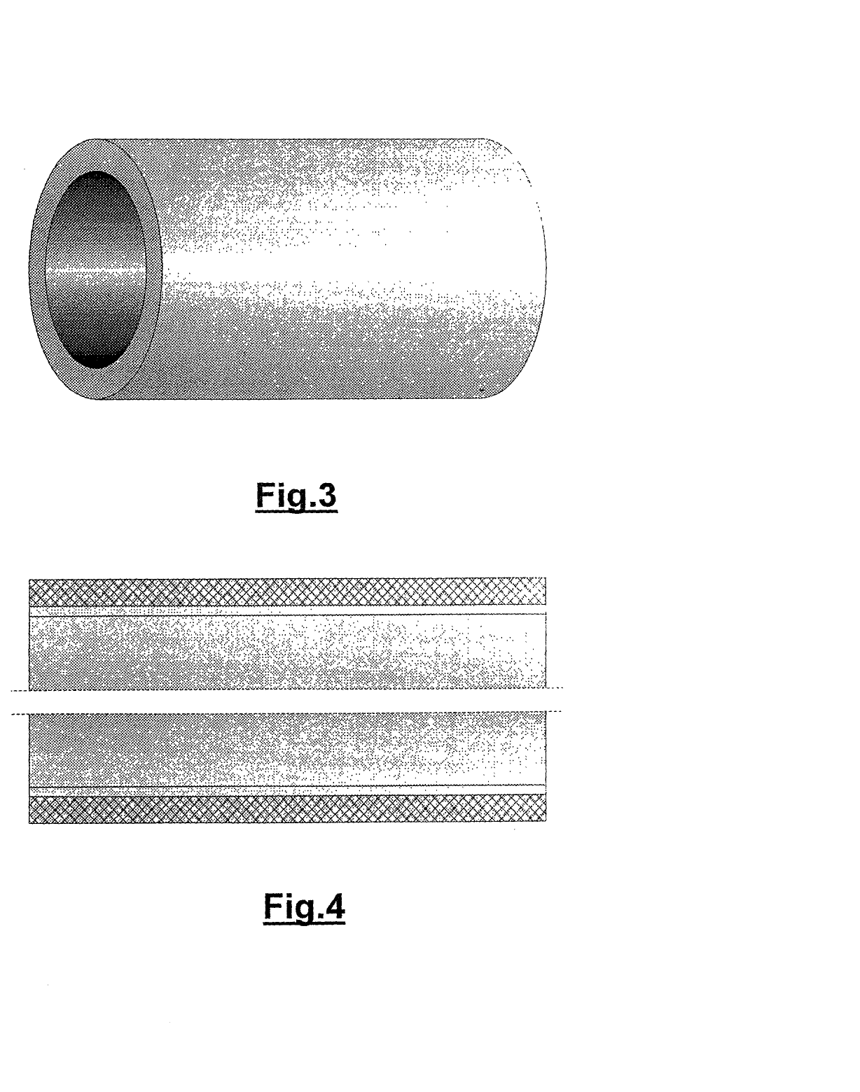

FIG. 3 represents a perspective view of a current state of the art sleeve.

FIG. 4 represents a front, sectional view of a current state of the art sleeve.

As can be inferred from the appended drawings that illustrate and compose the present descriptive patent report of a model of utility of “Polymeric Structured Sleeve for Flexographic Printing”, figure (1) shows the sleeve in a general view, comprising a polymeric structured sleeve (1) of one piece, hollow, straight, circular, cylindrical shape, made of elastomeric polymer (2) having a high hardness (seventy to eighty shore), having a thickness of up to one fourth of the total thickness of the polymeric structured sleeve (1), with one or more overlaid layers of structural textile (3) having a thickness of up to one fourth of the of the total thickness of the polymeric structured sleeve (1), being manufactured (wrapped around and along) at a forty-five degree angle over the elastomeric polymer (2) as a structural reinforcement, and another layer of elastomeric polymer (4) of variable hardness (twenty to eighty shore) with a thickness of up to two-fourths of the total thickness of the polymeric structured sleeve (1), being manufactured (wrapped around and along) the structured textile (3), serving as a base for laser engraving and having an inner diameter smaller than the mandrel's outer diameter in order to ensure a perfect mechanical fitting between both (sleeve and mandrel) during assembly and that may have variable outer diameter, thickness and/or length dimensions, with only a fixed inner diameter dimension (standardized with the mandrels).

The manufacture of the polymeric structured sleeve for flexographic printing is performed in four stages in a single manufacture process. First stage being the addition of high hardness elastomeric polymer on a cylindrical mold of a tool mandrel having a diameter calculate to compensate for the dimensional increment during the vulcanizing process. The second stage comprises the addition of a structural textile (3) on top of the first layer of elastomeric polymer (2), with the fibers positioned at an angle of around forty-five degrees to prevent the sleeve's torsion during the printing process which allows its use even in high graphic quality printing, as the images register of is highly accurate. In the third stage of the manufacturing process, the addition of the final layer of elastomeric polymer (4) takes place, being different for each type of ink and graphics to be engraved on the sleeve surface. In the fourth and last stage the vulcanization of this reinforced polymeric structure is performed, making the elastomeric polymers elastic, strong and insoluble to the chemical agents of printing inks. With this structure and production process, the polymeric structured sleeve (1) has excellent characteristics, among which are the high strength and flexibility which allows a temporary flattening of its diameter to facilitate the storage thereof, occupying a smaller volume.

The insertion of the polymeric structured sleeve (1) to the mandrel is done by injecting compressed air thereby achieving an air cushion around the mandrel. During this compressed air injection operation, the polymeric structured sleeve (1) is inserted to the mandrel by the side with a smooth sliding movement. The easy positioning of the polymeric structured sleeve (1) along the mandrel, is only possible by simultaneous application of compressed air which expands (dilates) the polymeric structured sleeve (1), increasing its inner diameter and thereby allowing the coaxial displacement. After stopping the compressed air injection, the inner diameter of the polymeric structured sleeve (1) contracts (decreases), thereby adjusting the polymeric structured sleeve (1) in an interference fit over the mandrel's outer surface that is, the former will be attached to the later forming a compact unit comprised of the polymeric structured sleeve (1) and the mandrel. The removal of the sleeve (1) is done by injecting compressed air, thereby creating an air cushion on the interface between the mandrel and the polymeric structured sleeve (1). During this operation, the polymeric structured sleeve (1) placed on the mandrel expands increasing its inner diameter and allowing the sleeve removal from the mandrel through the side with a smooth sliding out movement. Similar to the insertion of the polymeric structured sleeve (1) on the mandrel, this removal of the polymeric structured sleeve (1) along the mandrel is done with an easiness and smoothness that is only possible by simultaneous application of compressed air which allows coaxial movement. The polymeric structured sleeve for flexographic printing has advantages such as quick chance of services, a decrease in the need of cylinders in the process, low weight, easy maintenance, a less storage space for the polymeric structured sleeve (1), due to the flexibility and the possibility to store sleeves in vertical position, a much shorter manufacturing time and a one step manufacturing process.

All of these attributes allow the classification of the polymeric structured sleeve for flexographic printing as being extremely useful for the utilization in all flexographic printing machines the sizes and dimensions may vary, depending on the utilization needs.

1.) “POLYMERIC STRUCTURED SLEEVE FOR FLEXOGRAPHIC PRINTING”, is characterized in that it comprises a polymeric structured sleeve (1) of a one piece, hollow, straight circular cylindrical shape, made of high strength (seventy to eighty shore) elastomeric polymer (2) having a thickness up to one-fourth of the total thickness of the polymeric structured sleeve (1), with one or more overlaid structural synthetic layers (3) having a thickness up to one-fourth the total thickness of the polymeric structured sleeve (1), being manufactured (wrapped around and along) on the elastomeric polymer (2) at an angle (e.g. forty-five degrees) and another (layer) of elastomeric polymer (4) of variable hardness (twenty to eighty shore) having a thickness up to two-fourths of the total thickness of the polymeric structured sleeve (3) as a base for laser engraving and having an inner diameter smaller than the mandrel's outer diameter, and that may have varying outer diameter, thickness and/or length dimensions, with only the inner diameter dimension being a fixed one (standardized with the mandrels).
